(19) United States
(12) Patent Application Publication
(10) Pub. No.: US 2013/0062131 A1
(43) Pub. Date: Mar. 14, 2013

(54) Self-Generating Power Assembly For A Vehicle

(71) Applicant: Hencil Joel Cannon, Charlotte, NC (US)

(72) Inventor: Hencil Joel Cannon, Charlotte, NC (US)

(21) Appl. No.: 13/608,632

(22) Filed: Sep. 10, 2012

Related U.S. Application Data
(60) Provisional application No. 61/573,643, filed on Sep. 9, 2011.

(51) Int. Cl. B60L 11/18; B60K 1/02

(52) U.S. Cl. 180/65.31; 180/65.1; 180/65.7

(57) ABSTRACT

The invention relates to a self generating power assembly for a vehicle including one or more power sources for a vehicle that increases the mileage efficiency for the vehicle.

### CROSS-REFERENCE TO PRIORITY APPLICATION

This application claims the benefit of and priority to U.S. Provisional Patent Application Ser. No. 61/573,643 filed Sep. 9, 2011, in the U.S. Patent and Trademark Office. This application incorporates the earlier provisional application by reference in its entirety.

### FIELD OF THE INVENTION

The invention relates to a self generating power assembly for a vehicle. In particular, the invention relates to a self generating power assembly including one or more power sources for a vehicle that increases the mileage efficiency for the vehicle.

### BACKGROUND OF THE INVENTION

A variety of electrical and hybrid vehicles are currently known. A number of these vehicles include a rechargeable battery, a gasoline engine, one or more electric motors and one or more drive assemblies, and combinations of the same. As a result of rising gasoline prices, automobile manufacturers are currently researching and producing such luck: hybrid vehicles in response. Nevertheless, the current models have failed to fully appreciate the mechanical efficiency as set forth in the present invention.

### SUMMARY OF THE INVENTION

The invention achieves mileage efficiency for a vehicle with a number of embodiments to include one or more electric power sources (e.g., batteries), one or more electric engines, and may include a gasoline powered engine.

The foregoing and other objects and advantages of the invention and the manner in which the same are accomplished will become clearer based on the following detailed description taken in conjunction with the accompanying drawings in which:

### BRIEF DESCRIPTION OF THE DRAWINGS

FIG. 1 is a perspective view of the subject invention; and

FIG. 2 is a perspective view of an element of the subject invention.

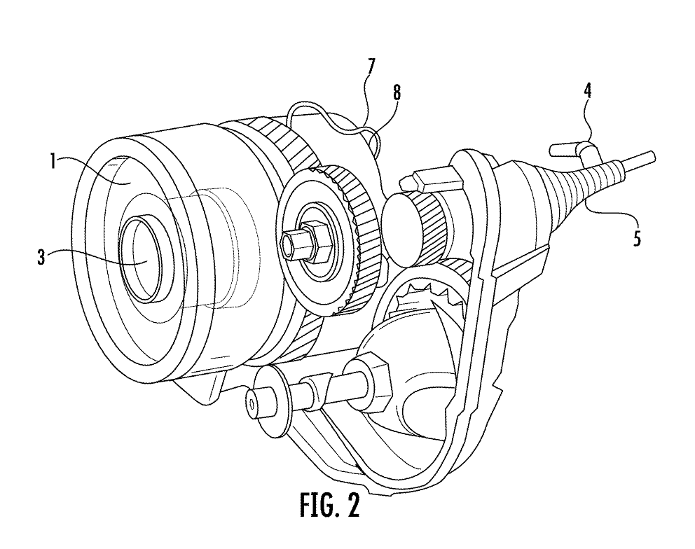

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood by those skilled in the art that as used herein the terms “operatively connected” and “in operative communication” refer to a condition of the invention whereby gears, shafts, sprockets, chains, belts, or the like are linked to one another such that movement of one element affects movement of another element.

It will be further appreciated by those of ordinary skill in the art that, as used herein, the concept of a shaft or gear being “between” two other shafts or gears does not necessarily imply that the three shafts or gears are contiguous (i.e., in intimate contact). Rather, as used herein, the concept of one shaft being between two other shafts is meant to describe the relative positions of the shafts within the drive assembly structure, respectively.

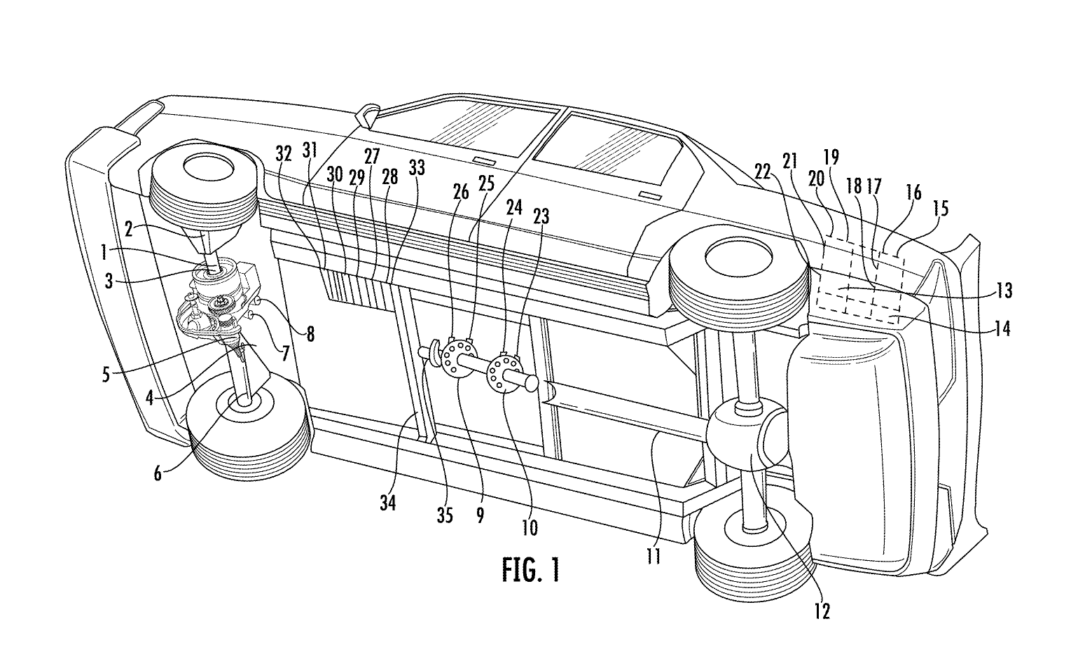

An overall view of the self-generating power assembly that incorporates features of the present invention is set forth in FIG. 1. As depicted in FIG. 1, the powered wheel assembly includes the following elements as numbered below:
1. Primary electric motor.
2. Left Axle assembly.
3. Planetary gear set.
4. Transfer case to left wheel assembly.
5. Standard front wheel automatic transmission.
6. Right wheel axle assembly.
7. Negative wire from primary electric motor to drive motor power generator inverter module.
8. Positive wire from primary electric motor to drive motor power generator inverter module.
9. Number two electric motor-generator.
10. Number three electric motor-generator.
11. Traditional drive shaft.
12. Traditional differential with a ratio of 17/3.
13. Number one lithium-ion battery.
14. Number two lithium-ion battery.
15. Negative wire from electric motor-generator number three.
16. Positive wire from electric motor-generator number three.
17. Negative wire to drive motor power generator inverter module.
18. Positive wire to drive motor power generator inverter module.
19. Negative wire from electric motor-generator number two.
20. Positive wire from electric motor-generator number two.
21. Negative wire to drive motor power generator inverter module.
22. Positive wire to drive motor power generator inverter module.
23. Negative wire to lithium battery number two.
24. Positive wire to lithium battery number two.
25. Negative wire to lithium battery number one.
26. Positive wire to lithium battery number one.
27. Negative wire to lithium battery number two.
28. Positive wire to lithium battery number two.
29. Negative wire to lithium battery number one.
30. Positive wire to lithium battery number one.
31. Negative wire to primary electric motor.
32. Positive wire to primary electric motor.
33. Drive motor power generator inverter module.
34. Pulley for belt to power air condition compressor.
35. Double pulley to drive 12 volt alternator for electrical current for all traditional accessories and heating capabilities.

Self generation is accomplished by inclusion of electric motor generators and the batteries (e.g., lithium ion batteries). Advantageously, the batteries are capable of accepting an electric current (i.e., recharging) simultaneously.

A standard lithium ion battery, when fully charged, provides a vehicle with enough power to travel a distance of approximately 40 miles. The self generating capability of the present invention provides an additional 30 miles of travel before the electrical current in the batteries is depleted. During generation of the electrical current, the invention undergoes approximately 25% loss of power due to friction and heat.

After traveling a distance of approximately 70 miles, the drive motor power generator inverter module switches on and begins to draw electrical current from one (e.g., the second) battery. While the vehicle travels another 70 miles, the self generating capability of the present invention fully recharges the first battery.

The switching between charging of the first and second battery alternates for the duration of travel.

The self-generating power assembly for a vehicle may comprise one or more (e.g., three) electric motors secured to the vehicle, one or more batteries (e.g., lithium ion) operatively connected to the electric motors, one or more axle assemblies operatively connecting the electric motors to the batteries, one or more axle assemblies for actuating one or more wheels of the vehicle, a drive shaft operatively connecting the batteries, the electric motors and the axle assemblies, and a drive motor power generator inverter module operatively connected to the batteries. Advantageously, the inverter module in a first mode is inoperative and in a second mode draws electrical current from the batteries to power the vehicle.

The one or more batteries are capable of being charged by the drive shaft simultaneously. The self-generating power assembly may also include a front and rear wheel assembly that is operatively connected to the vehicle and drive shaft.

In addition, the self-generating power assembly includes an automatic transmission for operating the front wheel assembly. Moreover, the invention may include a planetary gear set operatively connecting the one or more electric motors and the one or more axle assemblies, a differential operatively connecting the rear wheel assembly, and one or more electrical connections (e.g., wires) that connect the one or more batteries, the one of more electric motors, and the drive motor power generator inverter module. The axle assemblies may include a left axle assembly and a right axle assembly.

In the drawings and specification, there have been disclosed typical embodiments on the invention and, although specific terms have been employed, they have been used in a generic and descriptive sense only and not for purposes of limitation, the scope of the invention being set forth in the following claims.

That which is claimed is:

1. A self-generating power assembly for a vehicle, said power assembly comprising:
one or more electric motors secured to the vehicle;
one or more batteries operatively connected to said one or more electric motors;
one or more axle assemblies operatively connecting said one or more electric motors to said one or more batteries, said one or more axle assemblies actuating one or more wheels of the vehicle;
a drive shaft operatively connecting said one or more batteries, said one or more electric motors and said one or more axle assemblies; and
a drive motor power generator inverter module operatively connected to said one or more batteries; and
wherein said inverter module in a first mode being inoperative and in a second mode drawing electrical current from said one or more batteries to power the vehicle.

2. The self-generating power assembly according to claim 1, wherein:
said one or more batteries accept charging from said drive shaft simultaneously.

3. The self-generating power assembly according to claim 1, further comprising:
front and rear wheel assemblies operatively connected to said vehicle and said drive shaft.

4. The self-generating power assembly according to claim 3, further comprising:
an automatic transmission for operating said front wheel assembly.

5. The self-generating power assembly according to claim 3, further comprising:
a planetary gear set operatively connecting said one or more electric motors and said one or more axle assemblies;
a differential operatively connecting said rear wheel assembly; and
one or more electrical connections (wires) connecting said one or more batteries, said one of more electric motors, and said drive motor power generator inverter module.

6. The self-generating power assembly according to claim 1, wherein said one or more axle assemblies includes a left axle assembly and a right axle assembly.

7. A self-generating power assembly for a vehicle, said power assembly comprising:
one or more electric motors secured to the vehicle;
one or more batteries operatively connected to said one or more electric motors;
one or more axle assemblies operatively connecting said one or more electric motors to said one or more batteries, said one or more axle assemblies actuating one or more wheels of the vehicle;
a drive shaft operatively connecting said one or more batteries, said one or more electric motors and said one or more axle assemblies;
a drive motor power generator inverter module operatively connected to said one or more batteries; and
positive and negative leads and wires operatively connecting said one or more electric motors, drive motor power generator inverter module, and one or more batteries;
wherein said inverter module in a first mode being inoperative and in a second mode drawing electrical current from said one or more batteries to power the vehicle.
